(19) United States
(12) Patent Application Publication
(10) Pub. No.: US 2015/0249874 A1
(43) Pub. Date: Sep. 3, 2015

(54) OPTICAL COMMUNICATION APPARATUS AND OPTICAL COMMUNICATION METHOD

(71) Applicant: FUJITSU LIMITED, Kawasaki-shi (JP)

(72) Inventor: Toru KATAGIRI, Kawasaki (JP)

(73) Assignee: Fujitsu Limited, Kawasaki (JP)

(21) Appl. No.: 14/613,734

(22) Filed: Feb. 4, 2015

(30) Foreign Application Priority Data
Feb. 28, 2014 (JP) 2014-039614

(51) Int. Cl. H04Q 11/00

(52) U.S. Cl. CPC H04Q 11/0005; H04Q 2011/0088

(57) ABSTRACT

An optical communication apparatus includes: a first interface unit configured to receive packets; a conversion unit configured to convert a header of a packet of the packets received by the first interface unit, which is to be transmitted to a device other than an adjacent relay device; and a second interface unit configured to transmit the packet of which the header is converted by the conversion unit.

### CROSS-REFERENCE TO RELATED APPLICATION

This application is based upon and claims the benefit of priority from the prior Japanese Patent Application No. 2014-039614 filed on Feb. 28, 2014, the entire contents of which are incorporated herein by reference.

### FIELD

The embodiments discussed herein are related to an optical communication apparatus and an optical communication method.

### BACKGROUND

Conventionally, a multilayer network composed of a packet network including, for example, a router, and an optical network including, for example, a WDM (Wavelength Division Multiplexing) device is utilized. FIG. 8 is a diagram for explaining a normal packet transfer in a conventional multilayer network. As illustrated in FIG. 8, user terminals U11 and U12 are connected to a router 201 of building A, a data center terminal D11 is connected to a router 202 of building B, and a data center terminal D12 is connected to a router 203 of building C. Since the transfer destination of packets is determined in respective routers 201, 202 and 203, for example, in a case where the user terminal U11 is communicating with the data center terminal D12, the packets are relayed from the WDM device 102 to the router 202 first and input to the WDM device 102 again.

However, since the processing of the router 202 is a simple transfer processing of packets, packets may be directly transferred from the WDM device 102 to a WDM device 103 without passing through the router 202 in order to reduce a transfer delay. FIG. 9 is a diagram for explaining a cut-through packet transfer in the conventional multilayer network. As illustrated in FIG. 9, in the conventional multilayer network, for example, the WDM device 101 and the router 201 are connected through an interface IF1, and the WDM device 103 and the router 203 are connected through an interface IF2. Accordingly, the WDM device 101 is able to receive only the packets addressed to the data center terminal D12 from the router 201 through the interface IF1. The WDM device 103 is able to transfer the packets addressed to the data center terminal D12 to the router 203 through the interface IF2. As a result, a cut-through transfer of packets which do not pass through the router 202 is implemented.

Related techniques are disclosed in, for example, Japanese Laid-Open Patent Publication No. 2003-69619 and Japanese Laid-Open Patent Publication No. 2012-204882.

A related technology is disclosed in Non-Patent Document 1 of Eiji OOKI, Daisaku SHIMAZAKI, Ryuichi MATSUZAKI, Ichiro INOUE, Kohei SHIOMOTO, “Multi-layer traffic engineering based on optical IP link server in IP optical network”, NTT Technical Journal, Telecommunications Association, January 2007, p. 18-21.

### SUMMARY

According to an aspect of the invention, an optical communication apparatus includes: a first interface unit configured to receive packets; a conversion unit configured to convert a header of a packet of the packets received by the first interface unit, which is to be transmitted to a device other than an adjacent relay device; and a second interface unit configured to transmit the packet of which the header is converted by the conversion unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram explaining a cut-through packet transfer in a multilayer network according to the present embodiment;

FIG. 2A is a diagram illustrating a packet transfer route at an initial state;

FIG. 2B is a diagram illustrating the packet transfer route at a cut-through state;

FIG. 3 is a diagram illustrating an overall configuration of network according to the present embodiment;

FIG. 4 is a diagram illustrating a configuration of a WDM device according to the present embodiment;

FIG. 5 is a diagram illustrating a configuration of a packet switch & processing unit of the WDM device according to the present embodiment;

FIG. 6A is a diagram illustrating a situation where packets are transferred at an initial state for a case where OH information is an MPLS label;

FIG. 6B is a diagram illustrating a situation where packets are transferred at a cut-through state for a case where OH information is an MPLS label;

FIG. 7A is a diagram illustrating a situation where packets are transferred at an initial state for a case where OH information is an MAC address;

FIG. 7B is a diagram illustrating a situation where packets are transferred at a cut-through state for a case where OH information is a MAC address;

FIG. 8 is a diagram for explaining a normal packet transfer in the conventional multilayer network; and

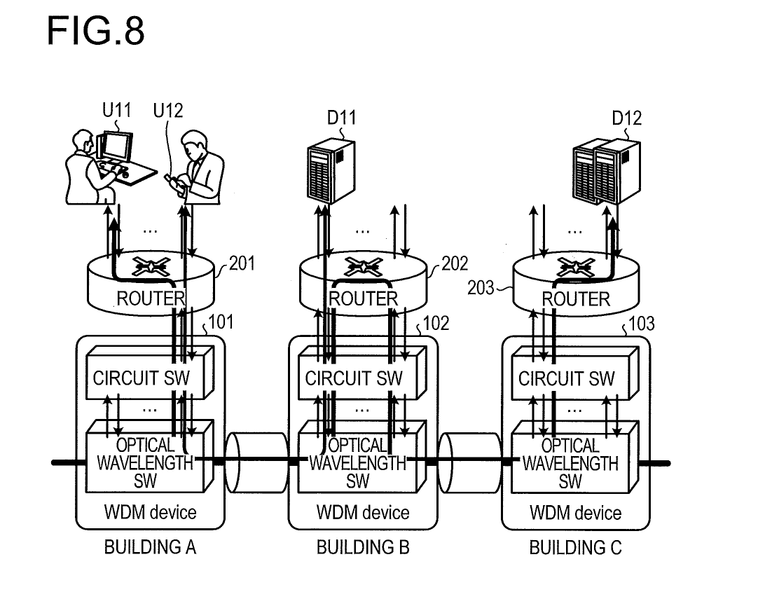

FIG. 9 is a diagram for explaining a cut-through packet transfer in the conventional multilayer network.

### DESCRIPTION OF EMBODIMENTS

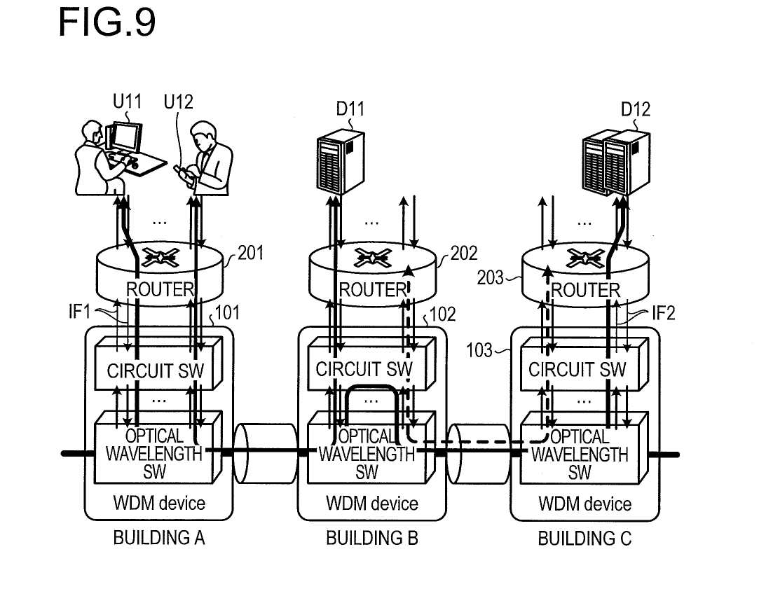

In the cut-through packet transfer described above, an interface is newly provided in the multilayer network so that adjacent routers are changed. For example, in the cut-through packet transfer illustrated in FIG. 9, an adjacent router of the router 201 is changed from the previous router 202 to the routers 202 and 203 due to the additional installation of the interfaces IF1 and IF2. Accordingly, a topology of the packet network which consists of the respective routers 201, 202 and 203 is changed and it takes a time for the routers 201, 202 and 203 to update (settle) a routing table in accordance with the change. That is, it may take a time for the respective routers 201, 202 and 203 to reconstruct the topology.

Hereinafter, embodiments of an optical communication apparatus and an optical communication method of the present disclosure will be described with reference to the accompanying drawings in detail. Further, the optical communication apparatus and the optical communication method of the present disclosure are not limited to the embodiments.

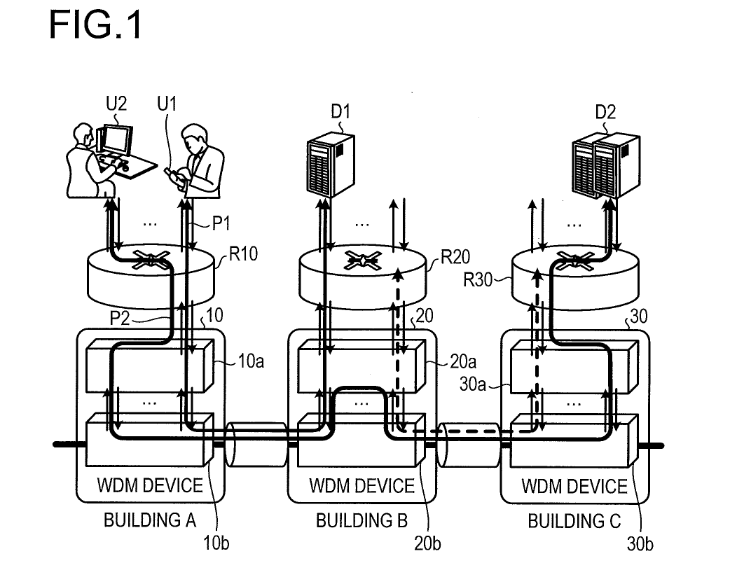

First of all, descriptions will be made on the configuration of a communication system according to an embodiment of the present disclosure. FIG. 1 is a diagram for explaining a cut-through packet transfer in the multilayer network according to the present embodiment. As illustrated in FIG. 1, in the present embodiment, the packets are classified, switched and distributed, and the OH (Over Head) information (e.g., label or address) of the packets is converted in a WDM device side rather than the router. Therefore, for example, a normal packet having a user terminal U1 as a transmission source and a cut-through packet having a user terminal U2 as a transmission source pass through a router R10 and are distributed in the WDM device 10 to arrive at different reception destinations. That is, the normal packet arrives at a data center terminal D1 via a WDM device 20 and a router R20 as illustrated in a normal path P1. In contrast, the cut-through packet cuts through the router R20 when being transmitted via the WDM device 20 and then arrives at a data center terminal D2 via a WDM device 30 and a router R30 as illustrated in a cut-through path P2. Accordingly, it becomes unnecessary to additionally install the interfaces between the router R10 and WDM device 10 and between the router R30 and the WDM device 30. Therefore, a cut-through packet transfer may be implemented without changing a network topology of packet network. In other word, an adjacent router of the router R10 remains router R20 although packet having a user terminal U2 is directly connected from router R10 to router R30 via the cut-through path P2.

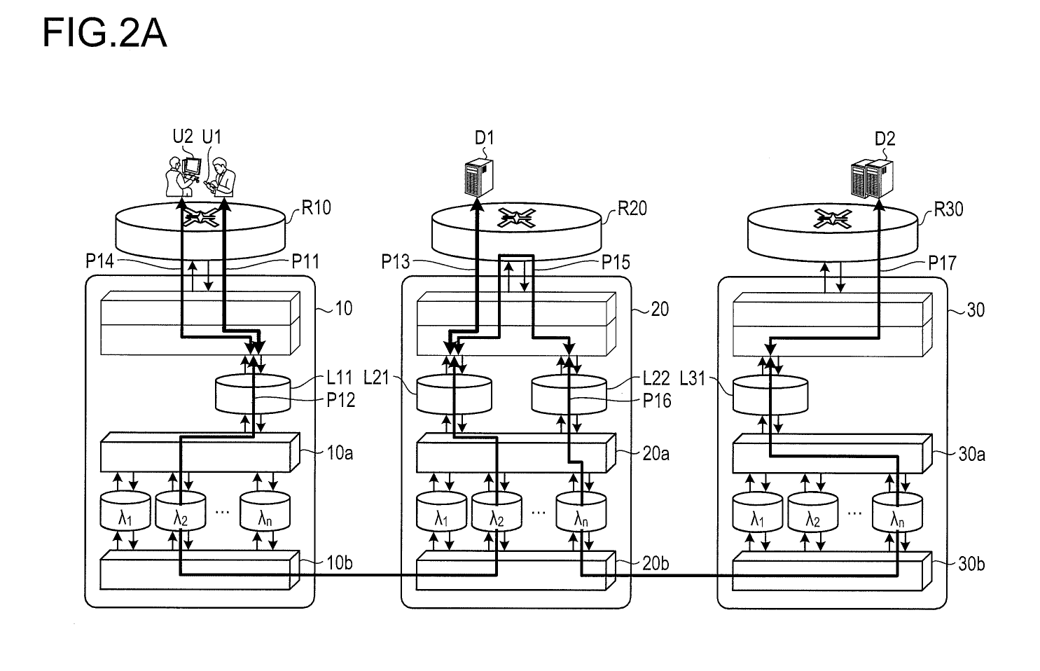

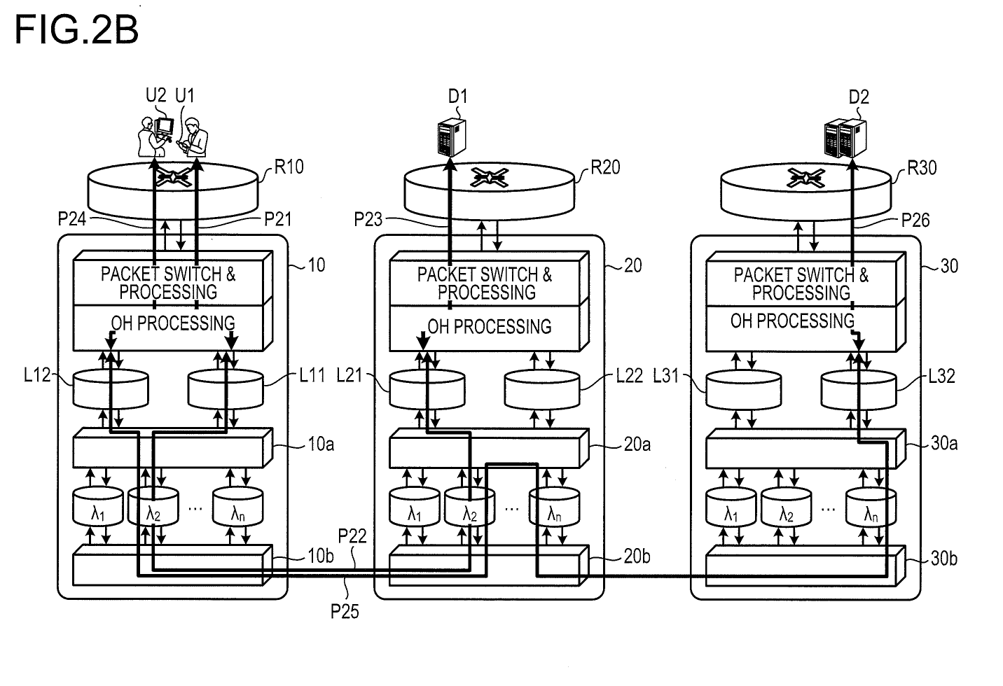

Next, the cut-through packet transfer according to the present embodiment will be more particularly described with reference to FIG. 2A and FIG. 2B. FIG. 2A is a diagram illustrating a packet transfer route at an initial state. As illustrated in FIG. 2A, at the initial state, a packet having the user terminal U1 as a transmission source and addressed to the data center terminal D1 arrives at a circuit L11 between WDM devices via a path P11 and then arrives at a circuit L21 between WDM devices via a path P12. Where the circuit is, for example, ODU (Optical channel Data Unit) interface of OTN (Optical Transport Network) as per ITU-T Recommendation G.709/Y.1331 Interfaces for the optical transport network. Circuit L11 and circuit L12 indicate the both ends of the path P12, here the path means ODU path as per ITU-T Recommendation G.709/Y.1331 Interfaces for the optical transport network. Thereafter, the packet arrives at the data center terminal D1 connected to a router R20 via a path P13. In the meantime, a packet addressed to the data center terminal D2 arrives at the router R20 via paths P14 and P12 and is subjected to a path switching (label swap) at the router R20. The packet arrives at a circuit L31 between WDM devices via paths P15 and P16 and then arrives at the data center terminal D2 connected to the router R30 via a path P17. Further, similar processing is performed for a packet to be transmitted in a reverse direction (a direction directed from the data center terminals D1 and D2 to the user terminals U1 and U2).

FIG. 2B is a diagram illustrating the packet transfer route at a cut-through state. As illustrated in FIG. 2B, since the packet having the user terminal U1 as a transmission source and addressed to a data center terminal D1 is a normal packet that does not cut through a router, the packet is distributed to the circuit L11 between WDM devices by a classification, switching and distribution processing as well as an OH conversion processing in the WDM device 10. Thereafter, the packet arrives at the circuit L21 between WDM devices via a path P22 and then arrives at the data center terminal D1 connected to the router R20 via a path P23.

In the meantime, since the packet addressed to the data center terminal D2 is a packet which cuts through the router R20, the packet is distributed to the circuit L12 between WDM devices by the classification, switching and distribution processing and then OH conversion processing in the WDM device 10. Thereafter, the packet arrives at a circuit L32 between WDM devices in a WDM device 30 via the WDM device 20 through the cut-through path P25 set between the WDM device 10 and the WDM device 30. Also, the packet arrives at the data center terminal D2 connected to the router R30 via a path P26. Further, similar processing is performed for a packet to be transmitted in a reverse direction (a direction directed from the data center terminals D1 and D2 to the user terminals U1 and U2).

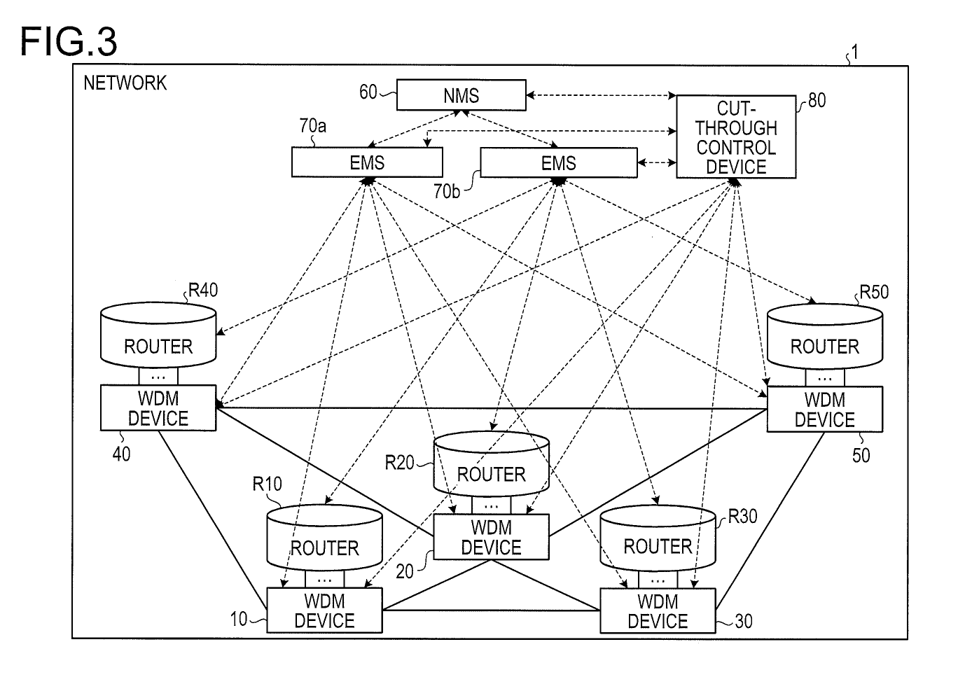

FIG. 3 is a diagram illustrating an overall configuration of network 1 according to the present embodiment. As illustrated in FIG. 3, the network 1 includes an NMS (Network Management System) 60, EMSs (Element Management Systems) 70a and 70b, and a cut-through control device 80 in addition to WDM devices 10, 20, 30, 40 and 50 and routers R10, R20, R30, R40 and R50.

The WDM devices 40 and 50 have the same configuration as those of the WDM devices 10, 20 and 30, and the routers R40 and R50 have the same configuration as those of the routers R10, R20 and R30. The NMS 60 is connected to the EMSs 70a and 70b and the cut-through control device 80 to operate and manage the entirety of the network 1. The EMS 70a manages and controls the WDM devices 10, 20, 30, 40 and 50 according to instructions from the NMS 60 and the cut-through control device 80. Similarly, the EMS 70b manages and controls the WDM devices 10, 20, 30, 40 and 50 according to instructions from the NMS 60 and the cut-through control device 80. Further, the cut-through control device 80 manages information for the cut-through transfer and controls the cut-through transfer by the WDM devices 10, 20, 30, 40 and 50. The cut-through control device 80 is, for example, a controller of SDN (Software-Defined Networking), and manages, for example, a reception destination of the packet to be subjected to the cut-through transfer and sets information used for the OH conversion of the packet in the respective WDM devices 10, 20, 30, 40 and 50.

Further, the EMS 70b is not necessarily needed in a case where the routers R10, R20, R30, R40 and R50 control its own router in a completely independent distribution fashion.

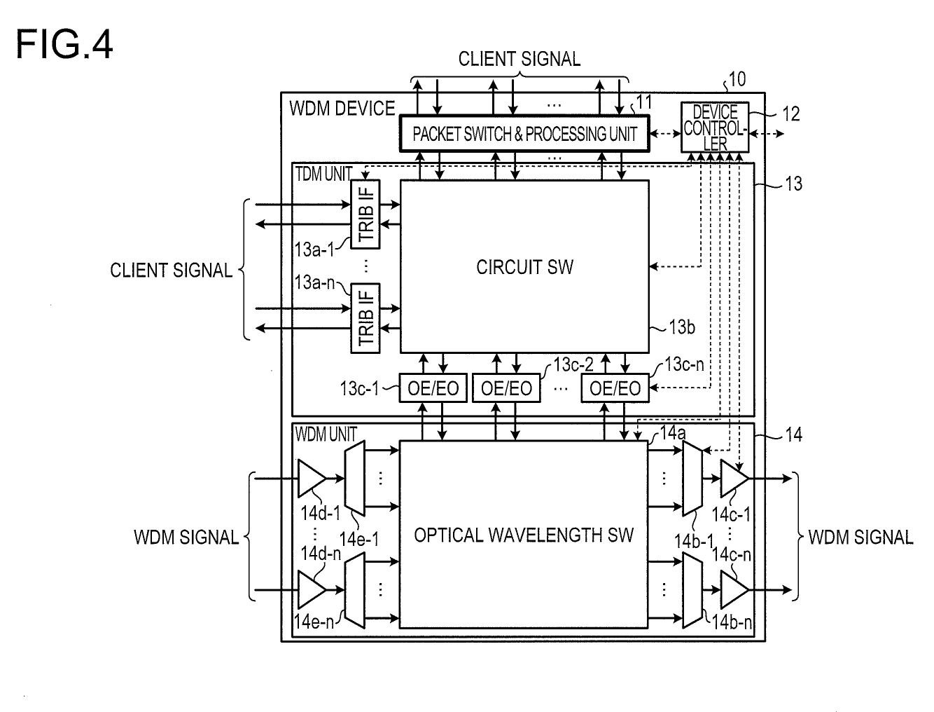

FIG. 4 is a diagram illustrating a configuration of the WDM device 10 according to the present embodiment. As illustrated in FIG. 4, the WDM device 10 includes a packet switch & processing unit 11, a device controller 12, a TDM (Time Division Multiplexing) unit 13 and a WDM unit 14. Respective constitutional units are connected with each one another such that various signals are able to be input thereto and output therefrom uni-directionally or bi-directionally.

When a client signal is received from the router R10, the packet switch & processing unit 11 extracts a packet from the client signal and then, aggregates the packet into a path signal having a predetermined frame length and bit rate, and outputs the packet to the TDM unit 13. Since a plurality of path signals exist for each reception destination of the packet, the packet is aggregated into the path signal that corresponds to the reception destination. Further, when the path signal is input from the TDM unit 13, the packet switch & processing unit 11 extracts the packet from the path signal and transmits the packet from an interface that corresponds to the reception destination of the packet. Here, the client signal is, for example, an Ethernet (registered trademark) signal or an ODU (Optical channel Data Unit) signal. Further, the packet is a signal such as, for example, an IP (Internet Protocol), MPLS (Multi-Protocol Label Switching), Ethernet (registered trademark) MAC (Media Access Control). The path signal is, for example, an ODU signal stipulated by the ITU-T G.709/Y.1331 Interfaces for Optical Transport Network (OTN) recommendations. Further, the path signal may be the STM (Synchronous Transfer Mode) stipulated by the ITU-T G.707 Network node interface for the Synchronous Digital Hierarchy (SDH) recommendations.

The device controller 12 instructs a circuit SW (SWitch) 13b to output a path signal input from an input port of the circuit SW 13b from a predetermined output port. Further, the device controller 12 instructs an optical wavelength SW 14a to output an optical signal input from an input port of the optical wavelength SW 14a from a predetermined output port.

When the client signal is received, the TDM unit 13 converts the client signal into an optical signal and outputs the optical signal into the WDM unit 14 or the packet switch & processing unit 11. Further, the TDM unit 13 extracts the path signal from the optical signal input from the WDM unit 14 and outputs the path signal to the packet switch & processing unit 11 as the client signal. The TDM unit 13 includes TRIB IFs 13a-1 to 13a-n, the circuit SW 13b and OE (Optical to Electrical)/EO (Electrical to Optical) 13c-1 to 13c-n. Further, n is an integer number of 2 or more.

The TRIB IFs 13a-1 to 13a-n aggregate the client signal into the path signal (e.g., an ODU signal) and output the path signal to the circuit SW 13b. Here, the client signal is a signal such as, for example, an Ethernet (registered trademark) signal, a Fibre Channel signal, or a SDH/SONET (Synchronous Digital Hierarchy/Synchronous Optical NETwork) signal. Further, the TRIB IFs 13a-1 to 13a-n may directly receive the path signal as an input and monitor the path signal, and then output the path signal to the circuit SW 13b.

The circuit SW 13b includes a plurality of input ports and a plurality of output ports. The circuit SW 13b outputs the path signals, which are input from the packet switch & processing unit 11 and the TRIB IFs 13a-1 to 13a-n to the respective input ports, from a predetermined output port according to an instruction from the device controller 12. Further, the circuit SW 13b outputs the path signals, which are input from the OE/EO 13c-1 to 13c-n to the respective input ports, from a predetermined output port according to an instruction from the device controller 12. For example, when the output port is connected to the packet switch & processing unit 11, the circuit SW 13b outputs the path signal to the output port as it is. In the meantime, when the output port is connected to the TRIB IFs 13a-1 to 13a-n, the circuit SW 13b connects the path signal to any one of the TRIB IFs 13a-1 to 13a-n and then the TRIB IFs 13a-1 to 13a-n extract the client signal from the path signal, and then outputs the client signal from the output port.

When the path signal output from the respective output port of the circuit SW 13b is input, the OE/EO 13c-1 to 13c-n convert the path signal into the optical signal and outputs the optical signal to the WDM unit 14. When a single path signal is received, the OE/EO 13c-1 to 13c-n adds an error correction code or OH information for monitoring control to the path signal to generate an OTU (Optical channel Transport Unit) signal and then convert the OTU signal from the electrical signal to the optical signal. In contrast, when a plurality of path signals are received, the OE/EO 13c-1 to 13c-n time divisionally multiplexes the plurality of path signals onto a second path signal (e.g., an ODU signal). Thereafter, the OE/EO 13c-1 to 13c-n add error correction code or OH information for monitoring control to the second path signal to generate the OTU signal and then converts the OTU signal from the electrical signal to the optical signal.

Further, when the optical signal is input from the WDM unit 14, the OE/EO 13c-1 to 13c-n convert the optical signal to electrical signal to extract the OTU signal. Thereafter, the OE/EO 13c-1 to 13c-n perform, for example, an error correction processing on the OTU signal and extract the path signal (e.g., an ODU signal) from the OTU signal. When the extracted OTU signal has a single path signal, the OE/EO 13c-1 to 13c-n output the path signals to the circuit SW 13b. In contrast, when a plurality of path signals are multiplexed onto the extracted OTU signal, the OE/EO 13c-1 to 13c-n separate the plurality of path signals and then output respective path signals to the circuit SW 13b.

The WDM unit 14 outputs an optical signal input from the TDM unit 13 and an optical signal for each of wavelengths λ₁ to λₙ included in the WDM signal input from outside. The WDM unit 14 includes an optical wavelength SW 14a, optical multiplexers 14b-1 to 14b-n, transmission side optical amplifiers 14c-1 to 14c-n and reception side optical amplifiers 14d-1 to 14d-n, and optical de-multiplexers 14e-1 to 14e-n.

The optical wavelength SW 14a includes a plurality of input ports and a plurality of output ports. The optical wavelength SW 14a outputs the optical signals, which are input from the OE/EO 13c-1 to 13c-n to respective input ports, from a predetermined output port according to the instruction from the device controller 12. Further, the optical wavelength SW 14a outputs the optical signals, which are input from the optical de-multiplexers 14e-1 to 14e-n to respective input ports, from a predetermined output port to the TDM unit 13 according to the instruction from the device controller 12. Further, the optical wavelength SW 14a outputs the optical signals, which are input from the optical de-multiplexers 14e-1 to 14e-n to respective input ports, from a predetermined output port to outside as the WDM signal according to the instruction from the device controller 12.

The optical multiplexers 14b-1 to 14b-n receive the optical signal output from an output port of the optical wavelength SW 14a for each wavelength as input signals and multiplexes the optical signals of a plurality of wavelengths λ₁ to λₙ. The optical multiplexers 14b-1 to 14b-n output the optical signal after being multiplexed to the transmission side optical amplifiers 14c-1 to 14c-n as the WDM signal. The transmission side optical amplifiers 14c-1 to 14c-n amplify light intensity of the WDM signal input from the optical multiplexers 14b-1 to 14b-n and transmit the WDM signal.

The reception side optical amplifiers 14d-1 to 14d-n amplify the light intensity of the WDM signal received from outside and output the WDM signal to the optical de-multiplexers 14e-1 to 14e-n. The optical de-multiplexers 14e-1 to 14e-n de-multiplex the WDM signals input from the reception side optical amplifiers 14d-1 to 14d-n into the optical signals of respective wavelengths λ₁ to λₙ and output the de-multiplexed WDM signals to the optical wavelength SW 14a.

As described above, the configuration of the WDM device 10 has been described as a representative configuration, but each of the WDM devices 20, 30, 40 and 50 has the same configuration as that of the WDM device 10. Therefore, common constitutional elements are assigned with reference numerals having the same end portion, and illustration and descriptions thereof will be omitted.

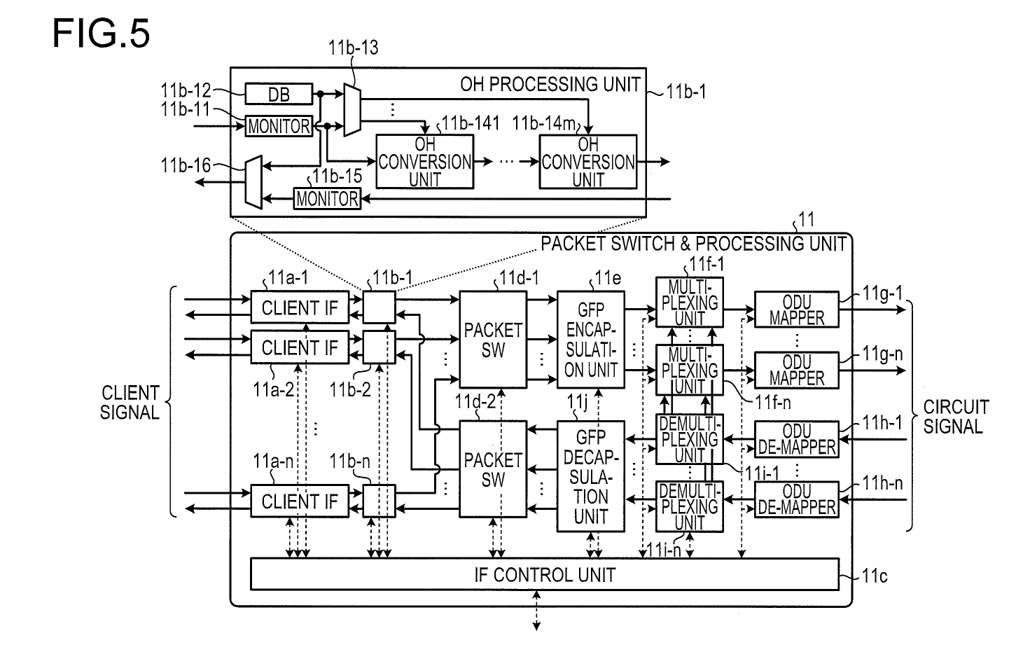

Next, the packet switch & processing unit 11 will be described with reference to FIG. 5 in more detail. FIG. 5 is a diagram illustrating a configuration of the packet switch & processing unit 11 of the WDM device 10 according to the present embodiment. As illustrated in FIG. 5, the packet switch & processing unit 11 includes client IFs (InterFace) 11a-1 to 11a-n, OH processing units 11b-1 to 11b-n, an IF control unit 11c, packet SWs (SWitch) 11d-1 and 11d-2, and a GFP (Generic Framing Procedure) encapsulation unit 11e. Further, the packet switch & processing unit 11 includes multiplexing units 11f-1 to 11f-n, ODU mappers 11g-1 to 11g-n, ODU de-mappers 11h-1 to 11h-n, demultiplexing units 11i-1 to 11i-n, and a GFP decapsulation unit 11j. Respective constitutional units are connected with each one another such that various signals are able to be input thereto and output therefrom uni-directionally or bi-directionally.

When the client signal (e.g., an Ethernet (registered trademark) signal, ODU signal) is received from the router R10, the client IFs 11a-1 to 11a-n extract the packet from the client signal and output the packet to corresponding OH processing units 11b-1 to 11b-n.

A monitor 11b-11 of the OH processing unit 11b-1 monitors the packet input from the client IF 11a-1. A comparison unit 11b-13 compares the monitoring result and data stored within a DB (Data Base) 11b-12. In the DB 11b-12, for example, a reception destination of the packet to be transferred through the cut-through transfer described above and information (e.g., label or address) used for the OH conversion of the packet are set in advance by the cut-through control device 80. Therefore, the OH processing unit 11b-1 compares the OH information (e.g., a reception destination) of the packet input from the client IF 11a-1 with data stored within the DB 11b-12 to become able to determine whether the packet is a target to be cut through. Further, the same processing as the OH processing unit 11b-1 is also performed in the OH processing units 11b-2 to 11b-n.

The OH conversion units 11b-141 to 11b-14m convert the OH information of the packet to be cut through based on the comparison result by the comparison unit 11b-13. The OH information to be converted is, for example, an IP address, an MPLS label, an Ethernet (registered trademark) MAC address, but is not limited to a single information and may include plural information. Further, when a plurality of OH information is converted, the packet switch & processing unit 11 may separately convert the OH information by configuring the conversion units 11b-141 to 11b-14m in a multistage structure as illustrated in FIG. 5, otherwise, may convert the plurality of OH information in a batch fashion in the OH conversion unit 11b-141. Further, “m” is a natural number.

The IF control unit 11c sets, for example, a reception destination of the packet to be transferred through the cut-through transfer described above and information (e.g., label or address) used for the OH conversion of the packet in the DB 11b-12 included in the OH processing units 11b-1 to 11b-n in advance according to the instruction from the cut-through control device 80.

When the packets after having been subjected to the OH conversion are input from the OH processing units 11b-1 to 11b-n, the packet SW 11d-1 performs a distribution of packets according to the reception destination based on the OH information of the packets. The GFP encapsulation unit 11e aggregates the packets input from the packet SW 11d-1 into GFP-F frame according to the ITU-T G.7041 Generic Framing Procedure (GFP) recommendations. When the GFP-F frame is input from the GFP encapsulation unit 11e, the multiplexing units 11f-1 to 11f-n multiplex the packets contained in the GFP frame with the packets of other ports. When the GFP-F frames are input from the corresponding multiplexing units 11f-1 to 11f-n, the ODU mapper 11g-1 to 11g-n aggregate the GFP-F frames into the path signal and output the path signal to the TDM unit 13.

The ODU de-mappers 11h-1 to 11h-n extract the GFP-F frame in which the packet is aggregated from the path signal input from the TDM unit 13. When the GFP-F frame are input from the ODU de-mappers 11h-1 to 11h-n, the demultiplexing units 11i-1 to 11i-n output the GFP-F frames to the multiplexing units 11f-1 to 11f-n and the GFP decapsulation unit 11j placed in a stage next to the demultiplexing units. The GFP decapsulation unit 11j extracts the packets from the GFP-F frames input from the demultiplexing units 11i-1 to 11i-n and outputs the packets to the packet SW 11d-2.

When the packets are input from the GFP decapsulation unit 11j, the packet SW 11d-2 performs a distribution of the packets according to the reception destination based on the OH information of the packets. The packets are input to the OH processing unit 11b-1 to 11b-n described above. For example, the packets input to the OH processing unit 11b-1 are monitored by the monitor 11b-15 and the monitoring result is compared with the data stored within the DB 11b-12 by the comparison unit 11b-16. As the comparison result, when there is a mismatch between the OH information of the packets and the OH information previously set in the DB 11b-12, the OH processing unit 11b-1 outputs an alarm signal notifying the existence of the mismatch to the IF control unit 11c. The client IFs 11a-1 to 11a-n aggregate the packets input from the corresponding OH processing units 11b-1 to 11b-n into the client signal (e.g., an Ethernet (registered trademark) signal, an ODU signal) and transmit the client signal to the router R10.

Further, in FIG. 5, the OH processing units 11b-1 to 11b-n which perform the OH conversion are placed in a stage ahead of the packet SWs 11d-1 and 11d-2. However, the placement of the OH processing units is not limited to an aspect described above and the packet switch & processing unit 11 may be configured such that the OH processing units 11b-1 to 11b-n are placed in a stage next to the packet SWs 11d-1 and 11d-2. That is, the WDM device 10 may convert the OH information of the cut-through packet after distributing the normal packet and the cut-through packet.

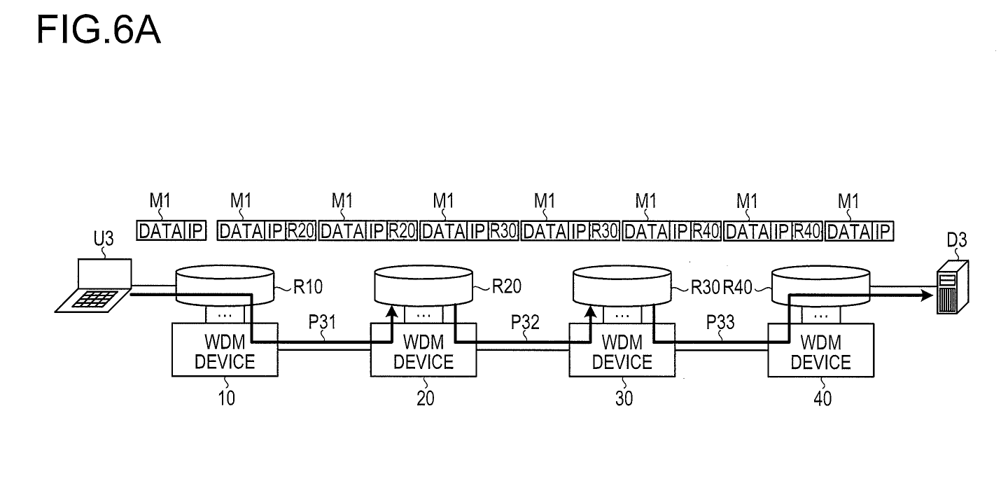

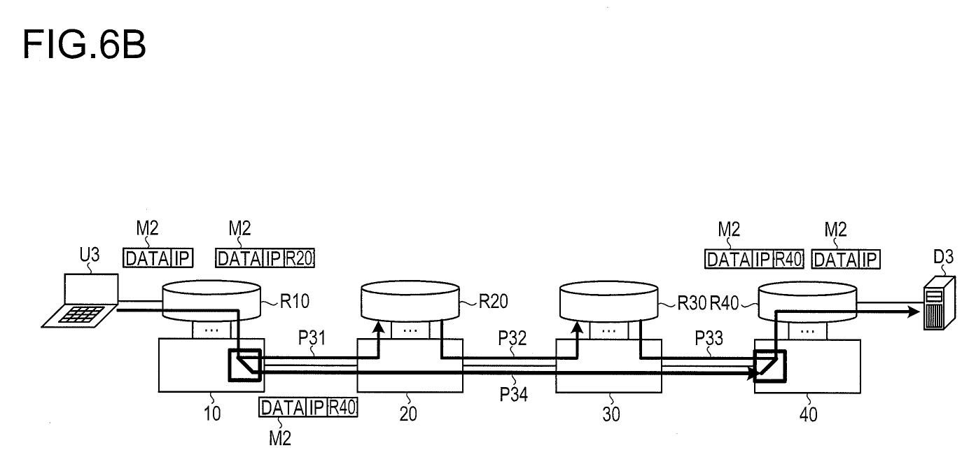

FIG. 6A is a diagram illustrating a situation where packets are transferred at an initial state for a case where the OH information is an MPLS label. As illustrated in FIG. 6A, the packet M1 of which transmission source is a user terminal U3 is assigned with an MPLS label “R20” as the OH information in the router R10. The packet M1 assigned with the MPLS label “R20” arrives at the router R20 via a path P31. In the router R20, the MPLS label of the packet M1 is converted from “R20” to “R30”. The packet M1 having the MPLS label “R30” arrives at the router R30 via a path P32. In the router R30, the MPLS label of the packet M1 is converted from “R30” to “R40”. The packet M1 having the MPLS label “R40” arrives at the router R40 via a path P33. In the router R40, the MPLS label “R40” is removed from the packet M1 and then the packet M1 is received by the data center terminal D3 which is a final reception destination.

FIG. 6B is a diagram illustrating a situation where packets are transferred at a cut-through state for a case where the OH information is an MPLS label. As illustrated in FIG. 6B, a packet M2 of which transmission source is the user terminal U3 is assigned with the MPLS label “R20” as the OH information in the router R10. When the packet M2 assigned with the MPLS label “R20” is distributed to the cut-through packet in the WDM device 10, a path for the packet M2 is switched to a cut-through path P34 different from the path P31. Further, in the WDM device 10, the MPLS label of the packet M2 is converted from “R20” to “R40”. The packet M2 having the MPLS label “R40” arrives at the router R40 via the cut-through path P34. In this case, since the packet M2 does not pass through the routers R20 and R30, a transfer delay or the load of the router is reduced. In the router R40, the MPLS label “R40” is removed from the packet M2 and then the packet M2 is received by the data center terminal D3 which is a final reception destination.

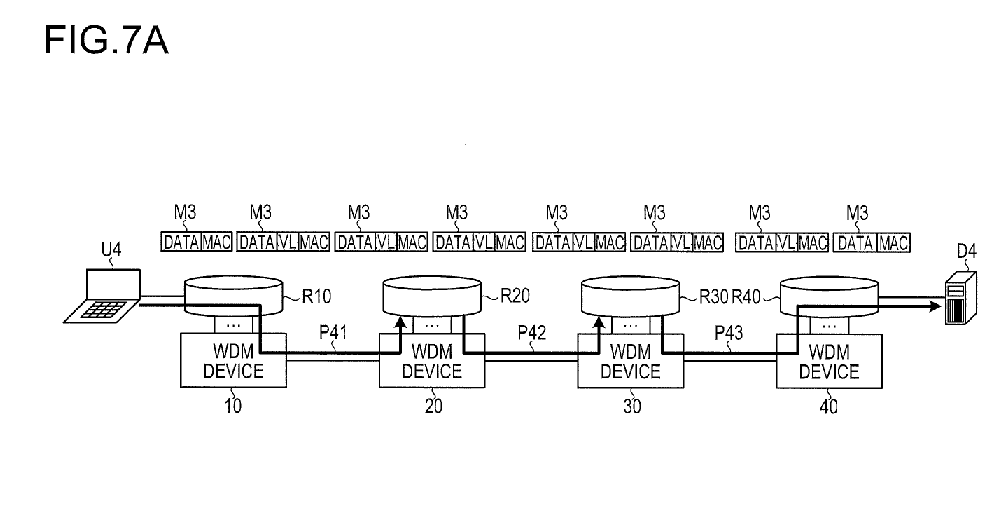

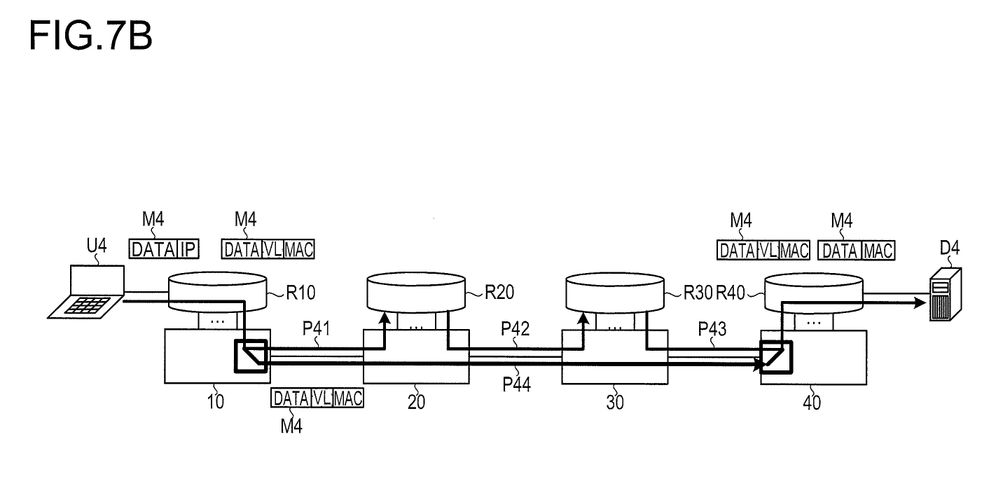

The packet transfer technology according to the present embodiment may also be applied to a MAC address in a VLAN (Virtual Local Area Network). FIG. 7A is a diagram illustrating a situation where packets are transferred at an initial state for a case where OH information is a MAC address. As illustrated in FIG. 7A, a packet M3 of which transmission source is a user terminal U4 is assigned with VLAN ID “VL” in the router R10. The packet M3 assigned with the VLAN ID arrives at the router R20 via a path P41. In the router R20, a reception destination MAC address “MAC” of the packet M3 is converted into the router R30. The packet M3 for which the router R30 is set as a reception destination MAC address arrives at the router R30 via a path P42. In the router R30, the reception destination MAC address “MAC” of the packet M3 is converted into the router R40. The packet M3 for which the router R40 is set as the reception destination MAC address arrives at the router R40 via a path P43. In the router R40, the VLAN ID is removed from the packet M3 and then the packet M3 is received by the data center terminal D4 which is a final reception destination.

FIG. 7B is a diagram illustrating a situation where a packet is transferred at a cut-through state for a case where OH information is an MAC address. As illustrated in FIG. 7B, the packet M4 of which transmission source is a user terminal U4 is assigned with a VLAN ID “VL” in the router R10. When the packet M4 assigned with the VLAN ID is distributed to cut-through packets in the WDM device 10, a path for the packet M4 is switched to a cut-through path P44 different from the path P41. Further, the reception destination MAC address of the packet M4 is converted into the router R40 in the WDM device 10. The packet M4 for which the router R40 is set as the reception destination MAC address arrives at the router R40 via the cut-through path P44. In this case, since the packet M4 does not pass through the routers R20 and R30, a transfer delay or the load of the router is reduced. In the router R40, the VLAN ID is removed from the packet M4 and then the packet M4 is received by the data center terminal D4 which is a final reception destination.

As described above, the WDM device 10 includes the packet switch & processing unit 11 provided with the client IF 11a-1 and the OH processing unit 11b-1, the TDM unit 13 and the WDM unit 14. The client IF 11a-1 receives the packet. The OH processing unit 11b-1 converts the header of the packet (cut-through packet) to be transmitted to a router other than the router R20 among the packets received by the client IF 11a-1. The WDM unit 14 transmits the packet of which header is converted by the OH processing unit 11b-1.

Accordingly, the WDM device 10 is able to perform the cut-through transfer without connecting the WDM device 10 and the router R20 through the interface. Therefore, the time is not required for reconstructing (e.g., updating of routing table) the network topology in order to resolve the change of the network topology occurred due to the connection through the interface. That is, the WDM device 10 is able to implement the cut-through transfer without changing the network topology. Further, the WDM device 10 is able to implement the cut-through transfer without increasing the number of interfaces (e.g., IF1 in FIG. 9) between the router (e.g., the router R10) and the WDM device 10. Therefore, it is possible to suppress the cost increase.

Further, in the WDM device 10, the OH processing unit 11b-1 may convert the head such that the reception destination of the packet is changed from the router R20 to the router R30 which is a device other than the router R20. Accordingly, the WDM device 10 may transmit the received packet to an intended reception destination through the cut-through transfer which does not require an additional installation of interface.

Further, in the WDM device 10, the OH processing unit 11b-1 may convert the head using information set by the cut-through control device 80. For example, the information may indicate an association relationship between a reception destination IP address (e.g., an IP address of the data center terminal D3 in FIG. 6B) of the packet and a reception destination router (e.g., the router R40). In this case, the WDM device 10 specifies the router (e.g., the router R40) which becomes a reception destination after the header is converted from the reception destination IP address of the packet. Accordingly, it becomes possible to comprehensively control the WDM device by the cut-through control device 80, so that for example, the WDM device 10 may transmit the packets through the cut-through transfer fashion while reducing the time required for reconstructing the network topology.

Further, in the WDM device 10, when an error is contained in the packet received by the client IF 11a-1, the OH processing unit 11b-1 may output the signal which notifies the error. An output destination for the signal is, for example, the client IF 11a-1, the IF control unit 11c, the packet and SW 11d-1. The error is notified to the user terminals U1 and U2 or the data center terminal D2 through, for example, the router R10 or the WDM device 20. Accordingly, when the received packet contains the error, a network manager or a user may easily and rapidly recognize that the error is contained in the packet.

Further, in the WDM device 10, the client IF 11a-1 may multiplex the packet (the normal packet) to be transmitted by passing through the router R20 and the packet (the cut-through packet) to be transmitted without passing through the router R20 that are received by the WDM unit 14, and transmit the multiplexed packets. Further, the reception destinations for the multiplexed packets may be either different for each packet (e.g., the user terminals U1 and U2 of FIG. 2B) or the same. Accordingly, the WDM device 10 may transmit the cut-through packet as well as the normal packet to the intended reception destination at high speed.

In addition, the router R20 may be a device that belongs to an upper layer than the WDM device 10. Accordingly, the WDM device 10 may implement the cut-through transfer for the packets transmitted and received between different layers without changing the network topology.

Further, in the embodiments described above, as illustrated in FIG. 2B, for example, the WDM device 20 transfers the packets via the circuit SW 20a in addition to the optical wavelength SW 20b upon performing the cut-through transfer. However, since the SW that the cut-through packet should pass through is determined depending on a mapping destination by the router R20, the packet may be transmitted only via the optical wavelength SW 20b placed in an optical stage without passing through the circuit SW 20a placed in an electrical stage.

Further, in the embodiments, the router is exemplified as a layer 3 packet device, but the packet device may be other network relay devices such as, for example, a layer 3 switch. Similarly, the WDM device may be, for example, an OTN (Optical Transport Network) device, a SDH (Synchronous Digital Hierarchy) device, a bridge, and a switching hub (layer 2 switch). Further, in the embodiments described above, the interface IF is adapted to establish the connection between layer 2 and layer 3, but the interface IF may be adapted to establish a connection between other layers such as, for example, between layer 3 and layer 4.

In addition, in the embodiments, the packet is assumed as a PDU (Protocol Data Unit) which is a target to be subjected to the OH conversion, but the embodiment is not limited to the packet as the PDU. For example, the embodiments may be applied to other PDUs, such as a frame of layer 2 protocol or a cell of ATM (Asynchronous Transfer Mode), according to the type of network.

Further, the interface which connects the WDM device and the router may be, for example, an Ethernet (registered trademark) card, but may include other network cards, such as a PC (Personal Computer) card. The number of routers that are cut through is exemplified as 1 (one) or 2 (two), but the number of routers may be three or more.

Further, in the above-described embodiments, respective constitutional elements of the WDM device 10 are not necessarily configured to be physically the same as those illustrated. That is, a specific shape of distribution and integration of the respective units is not limited to the shape illustrated and all or some of the units may be configured to be functionally and physically distributed and integrated in a certain device according to various loads or use situation. For example, the packet SW 11d-1 and the packet SW 11d-2 of the packet switch & processing unit 11, or the monitor 11b-11 and the monitor 11b-15 of the OH processing unit 11b-1, may be integrated as a single constitutional element, respectively. Otherwise, the device controller 12 illustrated in FIG. 4 may have a function of the IF control unit 11c illustrated in FIG. 5.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical communication apparatus comprising:
a first interface unit configured to receive packets;
a conversion unit configured to convert a header of a packet of the packets received by the first interface unit, which is to be transmitted to a device other than an adjacent relay device; and
a second interface unit configured to transmit the packet of which the header is converted by the conversion unit.

2. The optical communication apparatus according to claim 1, wherein the conversion unit is configured to convert the header of the packet such that a reception destination of the packet is changed from the adjacent relay device to a reception destination device other than the adjacent relay device.

3. The optical communication apparatus according to claim 1, wherein the conversion unit is configured to convert the header of the packet based on information set by an external device.

4. The optical communication apparatus according to claim 1, wherein, when the packet received by the first interface unit contains an error, the conversion unit is configured to generate a signal for notifying a destination of the packet of the error.

5. The optical communication apparatus according to claim 1, wherein the first interface unit is configured to multiplex a packet to be transmitted via the relay device and a packet to be transmitted without passing through the relay device and to transmit the multiplexed packets, the packets being received by the second interface unit.

6. The optical communication apparatus according to claim 1, wherein the relay device belongs to an upper layer than a layer to which the optical communication apparatus belongs.

7. An optical communication method comprising:
receiving packets;
converting a header of a packet of the received packets, which is to be transmitted to a device other than an adjacent relay device; and
transmitting the packet of the converted header, by an optical communication apparatus located adjacent to the relay device.
